(19) United States
(12) Patent Application Publication
(10) Pub. No.: US 2024/0051469 A1
(43) Pub. Date: Feb. 15, 2024

(54) VEHICLE SEAT HEADREST HAT AND APPAREL HOLDING DEVICES

(71) Applicant: MICHAEL O. FAHNLANDER, CAPE CORAL, FL (US)

(72) Inventor: MICHAEL O. FAHNLANDER, CAPE CORAL, FL (US)

(73) Assignee: MAD HATTER USA, LLC, CAPE CORAL, FL (US)

(21) Appl. No.: 17/885,586

(22) Filed: Aug. 11, 2022

(51) Int. Cl. B60R 7/10; B60N 2/879; B60R 7/04

(52) U.S. Cl. CPC B60R 7/10; B60N 2/879; B60R 7/043

(57) ABSTRACT

A hat and apparel holding device (1) for attachment to a vehicle headrest (6) having a frame portion (2) and a hook portion (4). The frame portion has an elongated middle section (16) with an open loop (8) at each end for securing the frame around two posts (7) of a vehicle headrest. The hook portion is attached at a proximal end to the middle section of the frame by loop (5), snap on (12), integration or other attachment and has at least one hook (4, 15) at a distal end for holding a hat or other apparel.

### BACKGROUND OF THE INVENTION

This invention relates to vehicle accessories and more particularly, to racks for holding hats, jackets and other apparel which are attachable to vehicle headrests.

Currently, motor vehicles, such as sedans, SUVs and pickup trucks do not have built in or accessory devices to hold hats, such as ball caps, cowboy hats and other headwear, in a secure, neat and readily accessible manner. Most often, such headwear is thrown or placed on a seat where it may be become displaced or dislodged during transit and become dirty or misshapen. Also, there's a danger of someone sitting or stepping on a hat and damaging same, many of which hats, such as cowboy hats, can be very expensive.

Thus, a need exists for a built in or accessory device that will enable one to hold hats in a secure, neat and readily accessible manner in a vehicle.

### SUMMARY OF THE INVENTION

The primary object of the present invention is to provide a device that is a vehicle accessory for holding hats and other apparel in a motor vehicle.

Another object of the present invention is to provide such a device that is attachable to a vehicle seat headrest.

A further object of the present invention is to provide such a device that makes hats and other apparel readily accessible to vehicle occupants.

An even further object of the present invention is to provide such a device that holds hats and other apparel in a secure and neat manner.

Another object of the present invention is to provide such a device that makes it safer to enter and particularly exit the bed of a truck in that it reduces the likelihood of injuries.

A further object of the present invention is to provide a such a device that is quick and easy to install as an accessory.

The present invention fulfills the above and other objects by providing A hat and apparel holding device attachable to a vehicle headrest, said hat and apparel holding device having a frame portion and at least one hook portion. The frame portion has an elongated middle section and an open loop at each end for wrapping around a post of a vehicle headrest. The hook portion has an attachment to the frame, an arm extending from the attachment and at least one hook at a distal end. In one aspect the hook portion comprises a plurality of substantially U-shaped hooks. In another aspect the hook portion comprises an upwardly extending two-prong hook, each prong of the hook having a tip for securing inside a brim of a cowboy hat. The attachment of the hook portion to the frame may be a circular loop that wraps around a circumference of the elongated middle section on the frame, a snap on claw attachment or an integrated attachment or some other form of attachment.

The above and other objects, features and advantages of the present invention should become even more readily apparent to those skilled in the art upon a reading of the following detailed description in conjunction with the drawings wherein there is shown and described illustrative embodiments of the invention.

### DESCRIPTION OF THE DRAWINGS

In the following detailed description, reference will be made to the attached drawings in which:

FIG. 1 is a top perspective view of the hat holding device of the present invention attached to a vehicle headrest;

FIG. 2 is a side view of a hat holding device of the present invention;

FIG. 3 is side perspective view of a hat holding device of the present invention attached to a vehicle head rest while holding ball caps;

FIG. 4 is a side perspective view of a cowboy hat holding version of device of the present invention holding a cowboy hat;

FIG. 5 is a top view of a cowboy hat holding version of the device of the present invention; and

FIG. 6 is a side view of the cowboy hat holding version of the device of the present invention.

### DESCRIPTION OF THE PREFERRED EMBODIMENTS

For purposes of describing the preferred embodiment, the terminology used in reference to the numbered components in the drawings is as follows:
1. hat and apparel holding device generally, generally
2. frame
3. arms
4. hook portion
5. arm to frame attachment
6. vehicle headrest
7. head rest post
8. frame post loop
9. vehicle seat
10. ball cap
11. cowboy hat holding prongs
12. snap on frame attachment
13. cowboy hat
14. frame holding cavity
15. cowboy hat hooks
16. middle section of frame
20. tipped hooks

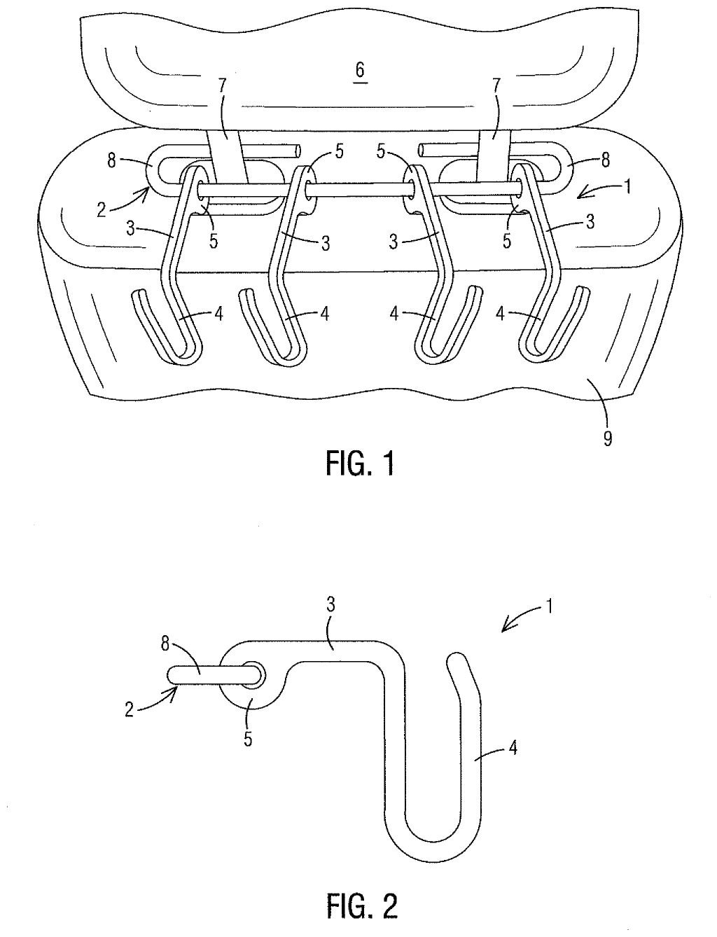

Referring to the drawing figures, FIG. 1 illustrates a top perspective view of the hat and apparel holding device, generally 1 of the present invention installed on a vehicle head rest 6 on a vehicle seat 9. The hat holding device 1 consists of two major components, a frame 2 and a hook portion 4. The frame 2 has open loops 8 on each end that wrap around the posts 7 of the head rest 6. The frame 1 is preferably made of a flexible material, such as plastic, so it can be easily opened to allow the loops 8 to fit around the headrest post 7. The hook portion 4 has one or more hooks 20 which are connected by arms 3 to the frame 2 by attachments 5.

FIG. 2 illustrates a side view of a hat and apparel holding device 1 of the present invention. In this view the frame 2 is shown with the hook portion 4 attached by an arm 3 to the frame 2 by a loop attachment 5 which allows as many hooks 20 as desired to be attached to the frame 2 by sliding the loop attachment 5 the ends of the loops 8 on the frame 1. Although a loop attachment 5 is illustrated in FIG. 2, the attachment may be integrated with the frame 1 or be of another type, such as of a snap on variety described hereinafter in relation to a cowboy hat holding version.

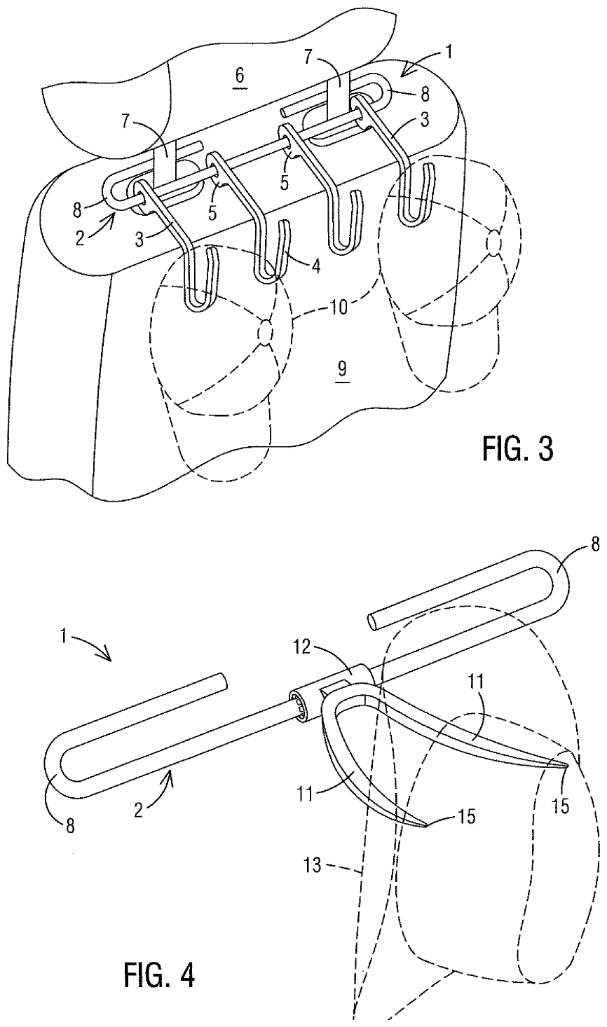

FIG. 3 illustrates a side perspective view of a hat and apparel holding device 1 of the present invention attached to a vehicle headrest 6 on a seat 9 with ballcaps 10 (shown in dashed line form) attached to the hooks 20. As discussed previously, the hat holding device 1 is secured by loops 8 on each side of the frame 2 placed around the posts 7 of the headrest 6.

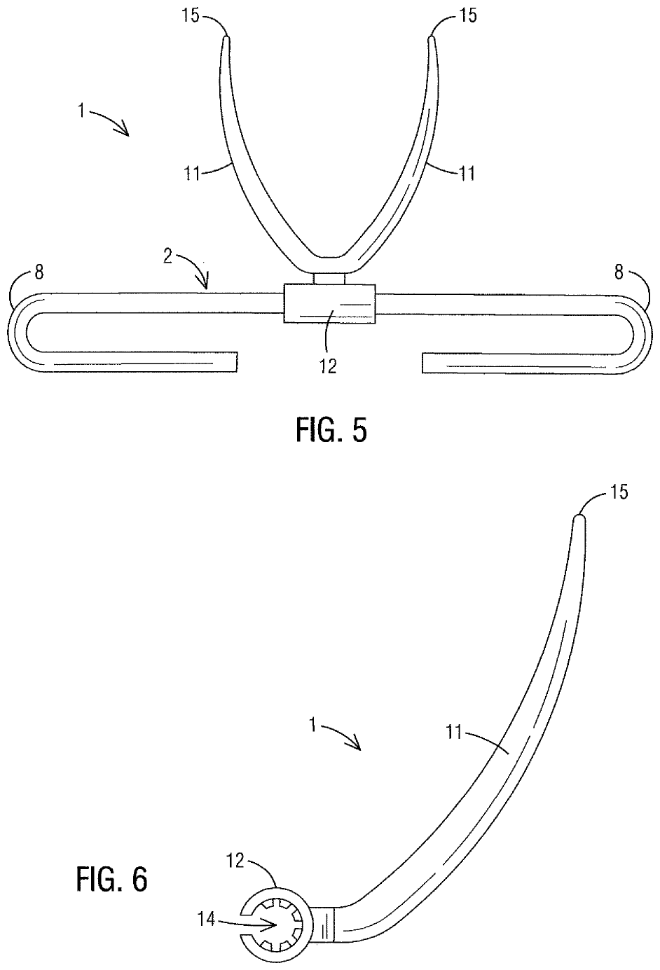

FIGS. 4, 5 and 6 illustrate a cowboy hat version of the hat and apparel holding device 1 of the present invention. As illustrated here, this device 1 has the same two major components, the frame 2 and hook portion 21, as the ball cap embodiment, the only differences from the previous version are that the hook portion 21 has attachment arms 11 that are shaped differently, in a somewhat horseshoe shape, and curve upward and the hooks 20 are tipped rather than U-shaped to accommodate the different shape of a cowboy hat 13 versus that of a ball cap 10 or other headwear. The tipped hooks 20 fit inside the brim of the cowboy hat to secure it in a safe fashion. Also, the attachment 12 illustrated here is of the snap on variety having a cavity 14 that wraps around the frame 2 which more securely holds the hooks 15 and arms 11 in a more stationary position than the looped attachment version 5 of the ball cap version. Maintaining an expensive cowboy hat in a stationary position is important as one does not want such a hat to be flopping around and getting damaged while driving.

It is to be understood that while preferred embodiments of the invention have been described, it is not to be limited to the specific form or arrangement of parts herein described and shown. It will be apparent to those skilled in the art that various changes may be made without departing from the scope of the invention and the invention is not to be considered limited to what is shown and described in the specification and/or drawings.

Having thus described my invention, I claim:

1. A hat and apparel holding device attachable to a vehicle headrest, said hat and apparel holding device comprising:
a frame having an elongated middle section and an open loop at each end for wrapping around a post of a vehicle headrest; and
at least one hook portion, said hook portion having an attachment to the frame at a proximal, an arm extending from the attachment and at least hook at a distal end.

2. The hat and apparel holding device of claim 1 wherein the at least one hook is substantially U-shaped.

3. The hat and apparel holding device of claim 1 wherein the at least one hook portion comprises an upwardly extending two-prong arm, each arm having a hook at a distal end for securing inside a brim of a cowboy hat.

4. The hat and apparel holding device of claim 1 wherein the attachment of the hook portion to the frame comprises a circular loop that wraps around a circumference of the elongated middle section on the frame.

5. The hat and apparel holding device of claim 1 wherein the attachment of the hook portion to the frame comprises a snap on claw that creates a friction-fit around a circumference of the elongated middle section of the frame.

6. The hat and apparel holding device of claim 1 wherein the frame portion is flexible.

7. The hat and apparel holding device of claim 1 wherein the attachment of the hook portion to the frame is integrated with the frame.
